(19) United States
(12) Patent Application Publication
(10) Pub. No.: US 2020/0407520 A1
(43) Pub. Date: Dec. 31, 2020

(54) POLYIMIDE-BASED FILM AND PREPARATION METHOD THEREOF

(71) Applicant: SKC CO., LTD., Gyeonggi-do (KR)

(72) Inventors: Dae Seong OH, Seoul (KR); Jung Hee KI, Gyeonggi-do (KR); Sunhwan KIM, Incheon (KR); Han Jun KIM, Gyeonggi-do (KR); Jin Woo LEE, Seoul (KR); Dong Jin LIM, Gyeonggi-do (KR); Dawoo JEONG, Gyeonggi-do (KR)

(21) Appl. No.: 16/912,974

(22) Filed: Jun. 26, 2020

(30) Foreign Application Priority Data
Jun. 28, 2019 (KR) 10-2019-0078286
Jul. 25, 2019 (KR) 10-2019-0090324

(51) Int. Cl. C08J 5/18; C08G 73/10

(52) U.S. Cl. CPC C08J 5/18; C08J 2479/08; C08G 73/1007

(57) ABSTRACT

The embodiments relate to a polyimide-based film, which comprises a first side and a second side opposite to the first side, wherein the modulus asymmetry (MA) according to Equation 1 is 0.03 to 0.2, a process for preparing the same, and a display device comprising the same.

### TECHNICAL FIELD

Embodiments relate to a polyimide-based film that is colorless, transparent, and excellent in mechanical properties and optical properties, and a process for preparing the same.

### BACKGROUND ART OF THE INVENTION

Since polyimide-based resins are resistant to friction and heat and excellent in chemical resistance, they are employed in such applications as primary electrical insulation, coatings, adhesives, resins for extrusion, heat-resistant paintings, heat-resistant boards, heat-resistant adhesives, heat-resistant fibers, and heat-resistant films.

For example, polyimide-based resins are made in the form of a powder and used as a coating for a metal or a magnetic wire. They are mixed with other additives depending on the applications thereof. In addition, polyimide-based resins are used together with a fluoropolymer as a painter for decoration and corrosion prevention. They also play a role of bonding a fluoropolymer to a metal substrate. In addition, polyimide-based resins are used to coat kitchenware, used as a membrane for gas separation by virtue of their excellent thermal resistance and chemical resistance, and used in natural gas wells for filtration of such contaminants as carbon dioxide, hydrogen sulfide, and impurities.

In recent years, polyimide-based resins have been developed in the form of a film by introducing an amide group to polyimide, which is less expensive and has excellent optical, mechanical, and thermal characteristics.

### DISCLOSURE OF THE INVENTION

### Problem to be Solved

Embodiments aim to provide a polyimide-based film that is colorless, transparent, and excellent in mechanical properties and optical properties, and a process for preparing the same.

### Solution to the Problem

The polyimide-based film according to an embodiment comprises a first side and a second side opposite to the first side, wherein the modulus asymmetry (MA) according to the following Equation 1 is 0.03 to 0.2:

$$MA = \frac{AM 2 - AM 1}{AM 2} \qquad [ Equation 1 ]$$

In Equation 1, AM1 is an AFM modulus measured from the first side by atomic force microscopy, AM2 is an AFM modulus measured from the second side by atomic force microscope, and AM2 is greater than AM1.

The process for preparing a polyimide-based film according to an embodiment comprises simultaneously or sequentially mixing and reacting an aromatic dianhydride compound, an aromatic diamine compound, and a dicarbonyl compound in an organic solvent to prepare a polyamide-imide solution; casting the polyamide-imide solution and then drying it to prepare a gel-sheet; thermally treating the gel-sheet, while it is moved on a belt, to prepare a cured film; and winding the cured film,

wherein the drying is carried out at a temperature of 60° C. to 200° C. for 10 minutes to 90 minutes,

the thermal treatment is carried out at 200° C. to 450° C. for 10 minutes to 120 minutes,

the AFM modulus of a first side of the cured film is 40 to 90 MPa, the AFM modulus of a second side opposite to the first side is 45 to 95 MPa, and the difference between the AFM modulus of the first side and the AFM modulus of the second side is MPa or less.

The cover window for a display according to an embodiment comprises a polyimide-based film having an AFM modulus of a first side of 40 to 90 MPa and an AFM modulus of a second side opposite to the first side of 45 to 95 MPa.

The display device according to an embodiment comprises a display panel; and a cover window disposed on the display panel,

wherein the cover window comprises a polyimide-based film,

the polyimide-based film comprises a first side and a second side opposite to the first side, and the modulus asymmetry (MA) in the polyimide-based film according to the above Equation 1 is 0.03 to 0.2.

### Advantageous Effects of the Invention

In the polyimide-based film according to the embodiment, the AFM modulus of a first side and the AFM modulus of a second side opposite to the first side satisfy specific numerical ranges, so that it is colorless, transparent, and enhanced in mechanical properties and optical properties such as haze, yellow index, and surface hardness.

### BRIEF DESCRIPTION OF THE DRAWINGS

FIG. 1 shows a cross-sectional view of a polyimide-based film according to an embodiment.

FIG. 2 is a cross-sectional view of a display device according to an embodiment.

FIG. 3 schematically illustrates process facilities for preparing a polyimide-based film according to an embodiment.

### DETAILED DESCRIPTION FOR CARRYING OUT THE INVENTION

Hereinafter, the present invention will be described in detail with reference to embodiments. The embodiments are not limited to those described below. Rather, they can be modified into various forms as long as the gist of the invention is not altered.

Throughout the present specification, in the case where each film, panel, layer, or the like is mentioned to be formed “on” or “under” another film, panel, layer, or the like, it means not only that one element is directly formed on or under another element, but also that one element is indirectly formed on or under another element with other element(s) interposed between them. In addition, the term on or under with respect to each element may be referenced to the drawings.

Throughout the present specification, when a part is referred to as “comprising” an element, it is understood that other elements may be comprised, rather than other elements are excluded, unless specifically stated otherwise.

All numbers and expressions relating to quantities of components, reaction conditions, and the like used herein are to be understood as being modified by the term “about” unless specifically stated otherwise.

The term “substituted” as used herein means to be substituted with at least one substituent group selected from the group consisting of deuterium, —F, —Cl, —Br, —I, a hydroxyl group, a cyano group, a nitro group, an amino group, an amidino group, a hydrazine group, a hydrazone group, an ester group, a ketone group, a carboxyl group, a substituted or unsubstituted alkyl group, a substituted or unsubstituted alkenyl group, a substituted or unsubstituted alkynyl group, a substituted or unsubstituted alkoxy group, a substituted or unsubstituted alicyclic organic group, a substituted or unsubstituted heterocyclic group, a substituted or unsubstituted aryl group, and a substituted or unsubstituted heteroaryl group. The substituent groups enumerated above may be connected to each other to form a ring.

Polyimide-Based Film

An embodiment provides a polyimide-based film that is colorless, transparent, and excellent in mechanical properties and optical properties such as haze, yellow index, and surface hardness.

The polyimide-based film according to an embodiment comprises a first side and a second side opposite to the first side, wherein the modulus asymmetry (MA) according to the following Equation 1 is 0.03 to 0.2:

$$MA = \frac{AM 2 - AM 1}{AM 2} \qquad [ Equation 1 ]$$

In Equation 1, AM1 is an AFM modulus measured from the first side by atomic force microscopy, AM2 is an AFM modulus measured from the second side by atomic force microscope, and AM2 is greater than AM1.

The first side may be one side of the polyimide-based film, and the second side may be the other side of the polyimide-based film.

The polyimide-based film may comprise a polyimide, or polyamide-imide, derived from an aromatic dianhydride compound, an aromatic diamine compound, and a dicarbonyl compound. Specifically, it may comprise a polyamide-imide.

The polyamide-imide may be prepared by simultaneously or sequentially reacting reactants that comprise an aromatic diamine compound, an aromatic dianhydride compound, and a dicarbonyl compound. Specifically, the polyamide-imide may be prepared by reacting an aromatic diamine compound, an aromatic dianhydride compound, and a dicarbonyl compound.

The polyamide-imide comprises an imide component derived from the polymerization of the aromatic diamine compound and the aromatic dianhydride compound and an amide component derived from the polymerization of the aromatic diamine compound and the dicarbonyl compound.

The aromatic diamine compound may form an imide bond with the aromatic dianhydride compound and form an amide bond with the dicarbonyl compound, to thereby form a copolymer.

The aromatic diamine compound may be a compound represented by the following Formula 1.

H₂N-(E)ₑ-NH₂ [Formula 1]

In Formula 1, E may be selected from the group consisting of a substituted or unsubstituted divalent C₆-C₃₀ aromatic cyclic group and a substituted or unsubstituted divalent C₄-C₃₀ heteroaromatic cyclic group.

e is selected from integers of 1 to 5. When e is 2 or more, the Es may be the same as, or different from, each other.

According to an embodiment, the aromatic diamine compound may comprise a compound having a fluorine-containing substituent. Alternatively, the diamine compound may be composed of a compound having a fluorine-containing substituent. In such event, the fluorine-containing substituent may be a fluorinated hydrocarbon group and specifically may be a trifluoromethyl group. But it is not limited thereto.

According to an embodiment, the aromatic diamine compound may comprise 2,2′-bis(trifluoromethyl)-4,4′-diaminobiphenyl (TFMB).

Since the dianhydride compound has a low birefringence value, it can contribute to enhancements in the optical properties such as transmittance of the polyimide-based film.

The aromatic dianhydride compound may be a compound represented by the following Formula 2.

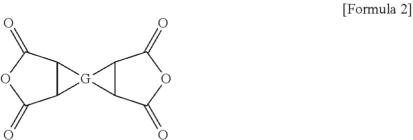

In Formula 2, G is a substituted or unsubstituted tetravalent C₆-C₃₀ aromatic cyclic group or a substituted or unsubstituted tetravalent C₄-C₃ heteroaromatic cyclic group, wherein the aromatic cyclic group or the heteroaromatic cyclic group may be present alone, may be combined to each other to form a condensed ring, or may be connected by a connecting group selected from a substituted or unsubstituted C₁-C₃₀ alkylene group, a substituted or unsubstituted C₂-C₃₀ alkenylene group, a substituted or unsubstituted C₂-C₃₀ alkynylene group, —O—, —S—, —C(═O)—, —CH(OH)—, —S(═O)₂—, —Si(CH₃)₂—, —C(CH₃)₂—, and —C(CF₃)₂—.

According to an embodiment, the aromatic dianhydride compound may comprise 2,2′-bis-(3,4-dicarboxyphenyl)hexafluoropropane dianhydride (6-FDA), 3,3′,4,4′-biphenyltetracarboxylic dianhydride (BPDA), or a combination thereof.

According to an embodiment, the aromatic dianhydride compound may comprise a compound having a fluorine-containing substituent. Alternatively, the aromatic dianhydride compound may be composed of a compound having a fluorine-containing substituent. In such event, the fluorine-containing substituent may be a fluorinated hydrocarbon group and specifically may be a trifluoromethyl group. But it is not limited thereto.

In another embodiment, the aromatic dianhydride compound may be composed of a single component or a mixture of two components.

For example, the aromatic dianhydride compound may comprise 2,2′-bis-(3,4-dicarboxyphenyl)hexafluoropropane dianhydride (6-FDA), but it not limited thereto.

According to an embodiment, the polyamide-imide may comprise 0 to 50 parts by weight of the aromatic dianhydride compound based on 100 parts by weight of the aromatic diamine compound. For example, the polyamide-imide may comprise 1 to 45 parts by weight, 3 to 45 parts by weight, or 3 to 40 parts by weight of the aromatic dianhydride compound, based on 100 parts by weight of the aromatic diamine compound.

The aromatic diamine compound and the aromatic dianhydride compound may be polymerized to form a polyamic acid.

Subsequently, the polyamic acid may be converted to a polyimide through a dehydration reaction, and the polyimide comprises an imide component.

The polyimide may form the following Formula A.

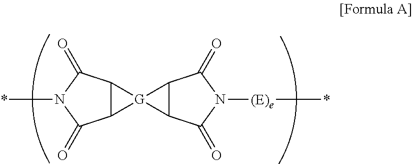

In Formula A, E, G, and e are as described in Formulae 1 and 2.

For example, the polyimide may comprise the following Formula A-1, but it is not limited thereto.

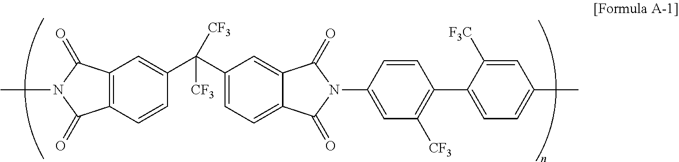

In Formula A-1, n is an integer of 1 to 400.

The dicarbonyl compound may be a compound represented by the following Formula 3.

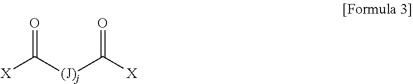

In Formula 3, J may be selected from the group consisting of a substituted or unsubstituted divalent C₆-C₃₀ aliphatic cyclic group, a substituted or unsubstituted divalent C₄-C₃₀ heteroaliphatic cyclic group, a substituted or unsubstituted divalent C₆-C₃₀ aromatic cyclic group, a substituted or unsubstituted divalent C₄-C₃₀ heteroaromatic cyclic group, a substituted or unsubstituted C₁-C₃₀ alkylene group, a substituted or unsubstituted C₂-C₃₀ alkenylene group, a substituted or unsubstituted C₂-C₃₀ alkynylene group, —O—, —S—, —C(═O)—, —CH(OH)—, —S(═O)₂—, —Si(CH₃)₂—, —C(CH₃)₂—, and —C(CF₃)₂—.

j is selected from integers of 1 to 5. When j is 2 or more, the Js may be the same as, or different from, each other.

X is a halogen atom. Specifically, X may be F, Cl, Br, or I. More specifically, X may be Cl, but it is not limited thereto.

According to an embodiment, the dicarbonyl compound may comprise terephthaloyl chloride (TPC), 1,1′-biphenyl-4,4′-dicarbonyl dichloride (BPDC), isophthaloyl chloride (IPC), or a combination thereof.

According to an embodiment, the dicarbonyl compound may be a mixture of at least two kinds of dicarbonyl compounds different from each other. Specifically, the dicarbonyl compound may comprise a first dicarbonyl compound and a second dicarbonyl compound.

The first dicarbonyl compound and the second dicarbonyl compound may be an aromatic dicarbonyl compound, respectively. If the first dicarbonyl compound and the second dicarbonyl compound are an aromatic dicarbonyl compound, respectively, it is possible to enhance the mechanical properties of the polyimide-based film thus produced such as surface hardness.

According to an embodiment, the first dicarbonyl compound may be terephthaloyl chloride, and the second dicarbonyl compound may be 1,1′-biphenyl-4,4′-dicarbonyl dichloride, isophthaloyl chloride, or a combination thereof.

Specifically, if the first dicarbonyl compound is terephthaloyl chloride and the second dicarbonyl compound is 1,1′-biphenyl-4,4′-dicarbonyl dichloride, or if the first dicarbonyl compound is terephthaloyl chloride and the second dicarbonyl compound is isophthaloyl chloride, it is possible to enhance the oxidation resistance of the polyimide-based film thus produced.

According to an embodiment, the polyamide-imide may comprise 50 to 100 parts by weight of the dicarbonyl compound based on 100 parts by weight of the aromatic diamine compound. For example, the polyamide-imide may comprise 55 to 100 parts by weight, 60 to 100 parts by weight, or 60 to 97 parts by weight of the dicarbonyl compound, based on 100 parts by weight of the aromatic diamine compound.

Specifically, the dicarbonyl compound may comprise 10 to 80 parts by weight of the first dicarbonyl compound based on 100 parts by weight of the dicarbonyl compound. For example, the dicarbonyl compound may comprise 15 to 80 parts by weight, 20 to 80 parts by weight, 25 to 80 parts by weight, 25 to 75 parts by weight, or 29 to 75 parts by weight of the first dicarbonyl compound, based on 100 parts by weight of the dicarbonyl compound.

In addition, the dicarbonyl compound may comprise 15 to 60 parts by weight of the second dicarbonyl compound based on 100 parts by weight of the dicarbonyl compound. For example, the dicarbonyl compound may comprise 15 to 55 parts by weight, 15 to 50 parts by weight, 20 to 50 parts by weight, or 22 to 47 parts by weight of the second dicarbonyl compound, based on 100 parts by weight of the dicarbonyl compound.

The aromatic diamine compound and the dicarbonyl compound may be polymerized to form the following Formula B.

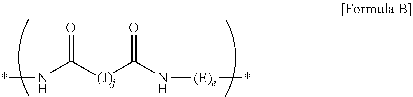

In Formula B, E, J, e, and j are as described in Formulae 1 and 3.

For example, the aromatic diamine compound and the dicarbonyl compound may be polymerized to form an amide component represented by the following Formula B-1 or B-2.

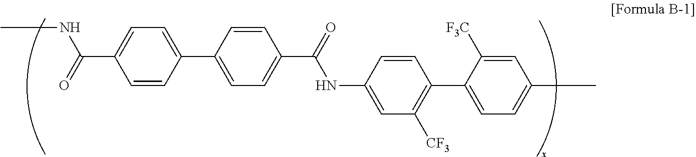

In Formula B-1, x is an integer of 1 to 400.

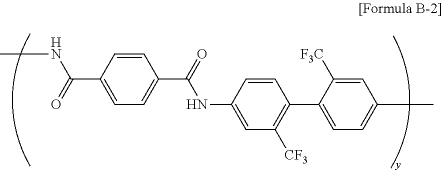

In Formula B-2, y is an integer of 1 to 400.

In another embodiment, the polyamide-imide may comprise the following Formula A and the following Formula B:

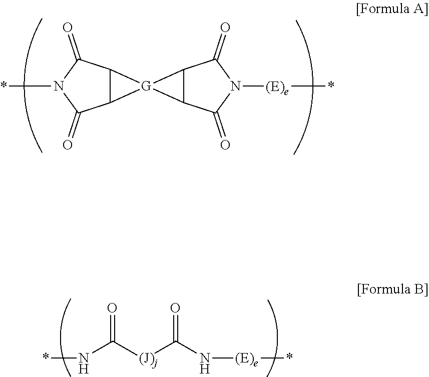

In Formulae A and B, E, G, J, e, and j are as described in Formulae 1 to 3.

The polyamide-imide comprises an imide component and an amide component. The molar ratio between the imide component and the amide component may be 0:100 to 50:50, 1:99 to 50:50, 2:98 to 50:50, 3:97 to 50:50, 5:95 to 50:50, 20:80 to 80:20, or 20:80 to 50:50. In such event, the imide component may be the above Formula A, and the amide component may be the above Formula B. If the above range is satisfied, it is easy to control the viscosity of the polyamide-imide and to prepare a uniform polyimide-based film having no defects on the surface thereof.

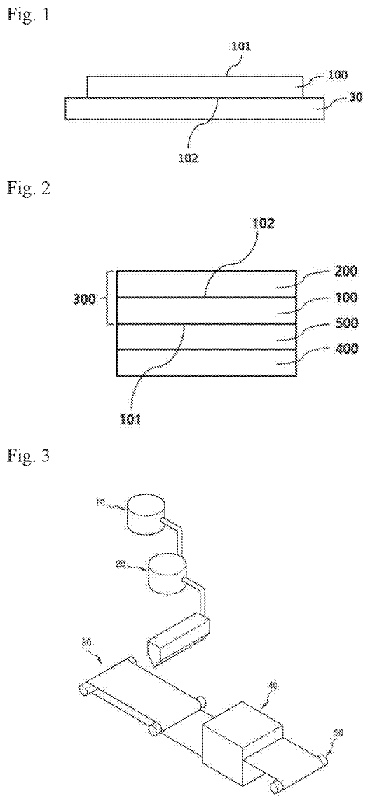

FIG. 1 shows a cross-sectional view of a polyimide-based film according to an embodiment. Specifically, FIG. 1 illustrates a polyimide-based film (100) that comprises a first side (101) and a second side (102) opposite to the first side (101).

The first side (101) may be a side that has not been in direct contact with the casting body (30) for casting the polyamide-imide in the process for preparing the polyimide-based film. That is, the first side (101) may be an air side in contact with the air when the polyamide-imide is cast.

The second side (102) may be a side that has been in direct contact with the casting body (30) in the process for preparing the polyimide-based film. That is, the second side (102) may be a belt side in contact with the casting body, for example, a belt in the casting step.

In the present specification, the AFM modulus of the first side or the second side opposite to the first side (one side or the other side) of the polyimide-based film may be measured by AFM equipment, specifically XE-150 (manufacturer: Park System). The AFM equipment may use a contact mode, a non-contact mode, or a tapping mode.

The AFM equipment may have different set values for a measuring device according to each mode. In the present specification, the AFM modulus and the AFM hardness are measured in a non-contact mode using the set values in Table 1 below.

TABLE 1

| | Non-contact mode |
|---|---|
| Force constant (N/m) | 0.2 |
| Resonance frequency (kHz) | 23 |
| Thickness (μm) | 1 |
| Mean width (μm) | 48 |
| Length (μm) | 225 |

According to an embodiment, the AFM modulus (AM1) of the first side of the polyimide-based film is 40 to 90 MPa, and the AFM modulus (AM2) of the second side of the polyimide-based film is 45 to 95 MPa.

For example, the AM1 of the polyimide-based film may be 45 to 90 MPa, 45 to 88 MPa, 50 to 88 MPa, 53 to 85 MPa, 55 to 83 MPa, 55 to 80 MPa, 55 to 75 MPa, or 59 to 72 MPa. The AM2 of the polyimide-based film is 50 to 95 MPa, 50 to 90 MPa, 53 to 90 MPa, 53 to 88 MPa, 55 to 85 MPa, 58 to 83 MPa, 60 to 83 MPa, 60 to 80 MPa, 60 to 78 MPa, 63 to 78 MPa, 63 to 75 MPa, or 63 to 73 MPa.

In such event, the modulus asymmetry (MA) according to the above Equation 1 may be 0.03 to 0.2, 0.03 to 0.18, or 0.03 to 0.15. If the above range is satisfied, it is possible to enhance the mechanical properties and optical properties of the polyimide-based film such as haze, yellow index, and surface hardness.

According to an embodiment, the difference between AM1 and AM2 of the polyimide-based film is 15 MPa or less. For example, the difference between AM1 and AM2 of the polyimide-based film may be 13 MPa or less, 12 MPa or less, 11 MPa or less, 1 to 15 MPa, 1 to 13 MPa, 1 to 12 MPa, 2 to 13 MPa, or 2 to 12 MPa. If the above range is satisfied, it is possible to enhance the mechanical properties and optical properties of the polyimide-based film such as haze, yellow index, and surface hardness.

According to an embodiment, the polyimide-based film may have a hardness asymmetry (HA) according to the following Equation 2 of 0.03 to 0.15, 0.03 to 0.1, or 0.03 to 0.08:

$$HA = \frac{AH 2 - AH 1}{AH 2} \qquad [ Equation 2 ]$$

In Equation 2, AH1 is an AFM hardness measured from the first side by atomic force microscopy, AH2 is an AFM hardness measured from the second side by atomic force microscope, and AH2 is greater than AH1.

According to an embodiment, the AH1 of the polyimide-based film may be 15 to MPa, and the AH2 thereof may be 18 to 50 MPa.

For example, the AH1 of the polyimide-based film may be 15 to 38 MPa, 18 to 38 MPa, 17 to 35 MPa, 17 to 34 MPa, 20 to 38 MPa, or 20 to 35 MPa. The AH2 of the polyimide-based film may be 18 to 40 MPa, 18 to 37 MPa, 20 to 50 MPa, 20 to 48 MPa, 20 to 45 MPa, 20 to 43 MPa, or 20 to 40 MPa. If the above ranges are satisfied, it is possible to enhance the mechanical properties and optical properties of the polyimide-based film such as haze, yellow index, and surface hardness.

According to an embodiment, the difference between AH and AH2 of the polyimide-based film is 10 MPa or less. For example, the difference between AH1 and AH2 of the polyimide-based film may be 8 MPa or less, 6 MPa or less, 5 MPa or less, 4 MPa or less, 3 MPa or less, 1 to 10 MPa, 1 to 8 MPa, 1 to 6 MPa, 1 to 5 MPa, 1 to 4 MPa, 1 to 3 MPa, or 1.5 to 3 MPa. If the above range is satisfied, it is possible to enhance the mechanical properties and optical properties of the polyimide-based film such as haze, yellow index, and surface hardness.

According to an embodiment, the tensile strength of the polyimide-based film may be 4.0 GPa or more. For example, the tensile strength of the polyimide-based film may be 5.0 GPa or more, 6.0 GPa or more, 6.5 GPa or more, 4.0 to 10.0 GPa, 4.5 to 10.0 GPa, 5.0 to 9.0 GPa, 5.5 to 9.0 GPa, 6.0 to 9.0 GPa, 6.3 to 8.5 GPa, 6.5 to 8.0 GPa, 6.5 to 7.8 GPa, or 6.5 to 7.4 GPa. If the above range is satisfied, it is possible to enhance the mechanical properties and optical properties of the polyimide-based film such as haze, yellow index, and surface hardness. Specifically, if the AFM moduli of the first side and the second side opposite to the first side of the polyimide-based film and the difference between the AFM moduli satisfy the above ranges, while the tensile strength of the polyimide-based film satisfies the above range, the effect of enhancing the mechanical properties and optical properties of the polyimide-based film is the best.

According to an embodiment, the surface hardness of the polyimide-based film may be 2H or higher. The surface hardness of the polyimide-based film may be 3H or higher, or 4H or higher.

According to an embodiment, the transmittance of the polyimide-based film may be 85% or more. For example, the transmittance of the polyimide-based film may be 86% or more, 87% or more, 88% or more, or 88.5% or more.

According to an embodiment, the polyimide-based film may have a haze of 3% or less. For example, the haze of the polyimide-based film may be 2.5% or less, 2.0% or less, 1.8% or less, 1.5% or less, 1.3% or less, 1.0% or less, 0.8% or less, or 0.6% or less.

According to an embodiment, the polyimide-based film may have a yellow index (Y.I.) of 5 or less. For example, the yellow index of the polyimide-based film may be 4.5 or less, 4.0 or less, 3.8 or less, or 3.6 or less.

According to an embodiment, the polyimide-based film may have a thickness of 10 μm to 200 μm. For example, the thickness of the polyimide-based film may be 10 μm to 180 μm, 20 μm to 150 μm, 20 to 130 μm, 25 to 100 μm, 30 to 80 μm, or 40 μm to 60 μm.

Process for Preparing a Polyimide-Based Film

The process for preparing a polyimide-based film according to an embodiment comprises simultaneously or sequentially mixing and reacting an aromatic dianhydride compound, an aromatic diamine compound, and a dicarbonyl compound in an organic solvent to prepare a polyamide-imide solution; casting the polyamide-imide solution and then drying it to prepare a gel-sheet; thermally treating the gel-sheet, while it is moved on a belt, to prepare a cured film; and winding the cured film.

The drying is carried out at a temperature of 60° C. to 200° C. for 10 minutes to 90 minutes. The thermal treatment is carried out at 200° C. to 450° C. for 10 minutes to 120 minutes.

The AFM modulus of a first side of the cured film is 40 to 90 MPa, the AFM modulus of a second side opposite to the first side is 45 to 95 MPa, and the difference between the AFM modulus of the first side and the AFM modulus of the second side is MPa or less.

Specifically, the process for preparing a polyimide-based film comprises simultaneously or sequentially mixing and reacting an aromatic diamine compound, an aromatic dianhydride compound, and a dicarbonyl compound in an organic solvent to prepare a polyamide-imide solution (S100); casting the polyamide-imide solution on a belt and then drying it to prepare a gel-sheet (S200); thermally treating the gel-sheet, while it is moved, to prepare a cured film (S300); cooling the cured film, while it is moved on a belt (S400); and winding the cured film using a winder (S500).

In the process for preparing a polyimide-based film, the polyamide-imide solution is prepared by simultaneously or sequentially mixing and reacting an aromatic diamine compound, an aromatic dianhydride compound, and a dicarbonyl compound in an organic solvent (S100).

The aromatic dianhydride compound, the aromatic diamine compound, and the dicarbonyl compound are the same as described above.

According to an embodiment, the polyamide-imide solution may be prepared by simultaneously mixing and reacting the aromatic diamine compound, the aromatic dianhydride compound, and the dicarbonyl compound in an organic solvent.

In another embodiment, the step of preparing the polyamide-imide solution may comprise first mixing and reacting the aromatic diamine compound and the aromatic dianhydride compound in a solvent to produce a polyamic acid (PAA) solution; and second mixing and reacting the polyamic acid (PAA) solution and the dicarbonyl compound to form an amide bond and an imide bond at the same time. The polyamic acid solution is a solution that comprises a polyamic acid.

In still another embodiment, the step of preparing the polyamide-imide solution may comprise first mixing and reacting the aromatic diamine compound and the aromatic dianhydride compound in a solvent to produce a polyamic acid solution; subjecting the polyamic acid solution to dehydration to produce a polyimide (PI) solution; and second mixing and reacting the polyimide (PI) solution and the dicarbonyl compound to further form an amide bond. The polyimide solution is a solution that comprises a polyamide-imide having an imide component.

In still another embodiment, the step of preparing the polyamide-imide solution may comprise first mixing and reacting the aromatic diamine compound and the dicarbonyl compound in a solvent to produce a polyamide (PA) solution; and second mixing and reacting the polyamide (PA) solution and the aromatic dianhydride compound to further form an imide bond. The polyamide solution is a solution that comprises a polyamide-imide having an amide component.

The polyamide-imide solution thus prepared may comprise at least one selected from the group consisting of a polyamic acid (PAA) component, a polyamide (PA) component, and a polyimide (PI) component.

Alternatively, the polyamide-imide solution comprises an imide component derived from the polymerization of the aromatic diamine compound and the aromatic dianhydride compound and an amide component derived from the polymerization of the aromatic diamine compound and the dicarbonyl compound.

According to an embodiment, the step of preparing the polyamide-imide solution may further comprise introducing a catalyst.

The catalyst may include, for example, beta picoline or acetic anhydride, but it is not limited thereto. The further addition of the catalyst may expedite the reaction rate and enhance the chemical bonding force between the structures of the respective components or that within the structures thereof.

In an embodiment, the step of preparing the polyamide-imide solution may further comprise adjusting the viscosity of the polyamide-imide solution.

Specifically, the step of preparing the polyamide-imide solution may comprise (a) simultaneously or sequentially mixing and reacting an aromatic diamine compound, an aromatic dianhydride compound, and a dicarbonyl compound in an organic solvent to prepare a first polyamide-imide solution; (b) measuring the viscosity of the first polyamide-imide solution and evaluating whether the target viscosity has been reached; and (c) if the viscosity of the first polyamide-imide solution does not reach the target viscosity, further adding the dicarbonyl compound to prepare a second polyamide-imide solution having the target viscosity.

The target viscosity may be 100,000 cps to 500,000 cps at room temperature. For example, the target viscosity may be 100,000 cps to 400,000 cps, 100,000 cps to 350,000 cps, 100,000 cps to 300,000 cps, 150,000 cps to 300,000 cps, or 150,000 cps to 250,000 cps at room temperature, but it is not limited thereto.

In another embodiment, the content of solids contained in the polyamide-imide solution may be 10 to 20% by weight. Specifically, the content of solids contained in the second polyamide-imide solution may be 12 to 18% by weight, but it is not limited thereto.

If the content of solids contained in the polyamide-imide solution is within the above range, a polyimide-based film can be effectively produced in the extrusion and casting steps. In addition, the polyimide-based film thus produced may have mechanical properties in terms of improved surface hardness and the like and optical properties in terms of a low yellow index and the like.

In an embodiment, the step of preparing the polyamide-imide solution may further comprise adjusting the pH of the polyamide-imide solution. In this step, the pH of the polyamide-imide solution may be adjusted to 4 to 7 or 4.5 to 7.

The pH of the polyamide-imide solution may be adjusted by adding a pH adjusting agent. The pH adjusting agent is not particularly limited and may include, for example, amine compounds such as alkoxyamine, alkylamine, and alkanolamine.

If the pH of the polyamide-imide solution is adjusted to the above range, it is possible to prevent the damage to the equipment in the subsequent process, to prevent the occurrence of defects in the film produced from the polyamide-imide solution, and to achieve the desired optical properties and mechanical properties in terms of yellow index and surface hardness.

The pH adjusting agent may be employed in an amount of 0.1 to 10% by mole based on the total number of moles of monomers in the polyamide-imide solution.

The step of preparing the polyamide-imide solution may further comprise purging with an inert gas. The step of purging with an inert gas may remove moisture, reduce impurities, increase the reaction yield, and impart excellent surface appearance and mechanical properties to the film finally produced.

The inert gas may be at least one selected from the group consisting of nitrogen, helium (He), neon (Ne), argon (Ar), krypton (Kr), xenon (Xe), and radon (Rn), but it is not limited thereto. Specifically, the inert gas may be nitrogen.

The molar ratio between the imide component and the amide component in the polyamide-imide used to prepare the polyamide-imide solution may be 0:100 to 50:50, 1:99 to 50:50, 2:98 to 50:50, 3:97 to 50:50, 5:95 to 50:50, 20:80 to 80:20, or 20:80 to 50:50. In such event, the imide component may be the above Formula A, and the amide component may be the above Formula B. If the above range is satisfied, it is easy to control the viscosity of the polyamide-imide and to prepare a uniform polyimide-based film having no defects on the surface.

It is possible to produce a polyimide-based film whose optical characteristics, mechanical properties, and flexibility are improved in a well-balanced manner without a complicated process by properly controlling the content of the imide component and that of the amide component. In addition, it is possible to provide a transparent polyimide-based film whose optical characteristics, mechanical properties, and flexibility are improved in a well-balanced manner without such steps as precipitation, filtration, drying, and redissolution as adopted in the prior art. The content of the imide component and that of the amide component may be controlled by the amounts of the aromatic dianhydride compound and the dicarbonyl compound, respectively.

FIG. 3 schematically illustrates process facilities for preparing a polyimide-based film according to an embodiment.

Specifically, the polyamide-imide solution as described above is prepared in a polymerization apparatus (10), and the polyamide-imide solution thus produced is transferred to, and stored, in a tank (20). Here, once the polyamide-imide solution has been prepared, the step of transferring the polyamide-imide solution to the tank is carried out without any additional steps.

The polyamide-imide solution prepared in the polymerization apparatus is transferred to, and stored in, the tank without any separate precipitation and redissolution steps for removing impurities. In the conventional process, in order to remove impurities such as hydrochloric acid (HCl) generated during the preparation of a polyamide-imide solution, the polyamide-imide solution thus prepared is purified through a separate step to remove the impurities, and it is then redissolved in a solvent. In this case, however, there has been a problem that the loss of the active ingredient increases in the step of removing the impurities, resulting in decreases in the yield.

Accordingly, the preparation process according to an embodiment ultimately minimizes the amount of impurities generated in the step of preparing the polyamide-imide solution or properly controls the impurities in the subsequent steps, even if a certain amount of impurities is present, so as not to deteriorate the physical properties of the final film. Thus, the process has an advantage in that a film is produced without separate precipitation or redissolution steps. In addition, the polyamide-imide solution is not ought to be subjected to such separate steps as precipitation, filtration, drying, and redissolution. Since the polyamide-imide solution produced in the polymerization step can be directly applied to the casting step, the yield can be remarkably enhanced.

The tank (20) is a place for storing the polyamide-imide solution before forming it into a film, and its internal temperature may be −20° C. to 20° C. For example, the internal temperature may be −20° C. to 15° C., −20° C. to 10° C., −20° C. to 5C, or −20° C. to 0° C., but it is not limited thereto.

If the temperature of the tank (20) is controlled to the above range, it is possible to prevent the polyamide-imide solution from deteriorating during storage and to lower the moisture content to thereby prevent defects of the film produced therefrom.

The process for preparing a polyimide-based film may further comprise carrying out vacuum degassing of the polyamide-imide solution transferred to the tank (20).

The vacuum degassing may be carried out for 30 minutes to 3 hours after depressurizing the internal pressure of the tank (20) to 0.1 bar to 0.7 bar. The vacuum degassing under these conditions may reduce bubbles in the polyamide-imide solution.

As a result, it is possible to prevent surface defects of the film produced therefrom and to achieve excellent optical properties such as haze.

In addition, the process for preparing a polyimide-based film may further comprise purging the polyamide-imide solution transferred to the tank (20) with an inert gas.

Specifically, the purging is carried out by purging the tank (20) with an inert gas at an internal pressure of 1 to 2 atm. The nitrogen purging under these conditions may remove moisture in the polyamide-imide solution, reduce impurities to thereby increase the reaction yield, and achieve excellent optical properties such as haze and mechanical properties.

The step of vacuum degassing and the step of purging the tank (20) with nitrogen gas are performed in a separate process, respectively. For example, the step of vacuum degassing may be carried out, followed by the step of purging the tank (20) with nitrogen gas, but it is not limited thereto.

The step of vacuum degassing and the step of purging the tank with nitrogen gas may improve the physical properties of the surface of the polyimide-based film thus produced.

Thereafter, the process may further comprise storing the polyamide-imide solution in the tank (20) for 12 hours to 360 hours. Here, the temperature inside the tank may be kept at −20° C. to 20° C.

The process for preparing a polyimide-based film may further comprise casting the polyamide-imide solution in the tank (20) and then drying it to prepare a gel-sheet (S200).

The polyamide-imide solution may be cast onto a casting body such as a casting roll or a casting belt.

Referring to FIG. 3, in an embodiment, the polyamide-imide solution may be applied onto a casting belt (30) as a casting body, and it is dried while it is moved to be made into a sheet in the form of a gel.

When the polyamide-imide solution is injected onto the belt (30), the injection amount may be 300 g/min to 700 g/min. If the injection amount of the polyamide-imide solution satisfies the above range, the gel-sheet can be uniformly formed to an appropriate thickness.

In addition, the casting thickness of the polyamide-imide solution may be 200 to 700 sm. If the polyamide-imide solution is cast to a thickness within the above range, the final film produced after the drying and thermal treatment may have an appropriate and uniform thickness.

According to an embodiment, the polyamide-imide solution is cast and then dried at a temperature of 60° C. to 200° C. for 10 minutes to 90 minutes to prepare a gel-sheet. The solvent of the polyamide-imide solution is partially or totally volatilized during the drying to prepare the gel-sheet. For example, the drying may be carried out at 60° C. to 200° C., 60° C. to 150° C., or 80° C. to 150° C. for 10 minutes to 60 minutes, 10 minutes to 30 minutes, or 10 minutes to 20 minutes. If the above ranges are satisfied, it is possible to enhance the mechanical properties and optical properties of the polyimide-based film thus prepared such as haze, yellow index, and surface hardness.

The viscosity of the polyamide-imide solution may be 100,000 cps to 500,000 cps at room temperature. For example, it may be 100,000 cps to 400,000 cps, 100,000 cps to 350,000 cps, or 150,000 cps to 350,000 cps. If the above range is satisfied, the polyamide-imide solution can be cast onto a belt in a uniform thickness without defects.

The process for preparing a polyimide-based film comprises thermally treating the gel-sheet while it is moved to prepare a cured film (S300).

Referring to FIG. 3, the thermal treatment of the gel-sheet may be carried out by passing it through a thermosetting device (40).

According to an embodiment, the thermal treatment may be carried out at 200° C. to 450° C. for 10 minutes to 120 minutes. For example, the thermal treatment may be carried out at 200° C. to 420° C., 250° C. to 420° C., 300° C. to 420° C., or 380° C. to 420° C. for 10 minutes to 60 minutes, 10 minutes to 30 minutes, or 10 minutes to 20 minutes. If the above ranges are satisfied, it is possible to enhance the mechanical properties and optical properties of the polyimide-based film thus prepared such as haze, yellow index, and surface hardness. Specifically, if the above ranges are satisfied, the gel-sheet may be cured to have an appropriate surface hardness and modulus, and the cured film may have high light transmittance and low haze at the same time.

According to an embodiment, the thermal treatment may be carried out at a temperature elevation rate of 2 to 80° C./min. For example, it may be carried out at a temperature elevation rate of 5 to 80° C./min or 10 to 80° C./min.

The process for preparing a polyimide-based film comprises cooling the cured film while it is moved (S400).

Referring to FIG. 3, the cooling of the cured film is carried out after it has been passed through the thermosetting device (40). It may be carried out by using a separate cooling chamber (not shown) or by forming an appropriate temperature atmosphere without a separate cooling chamber.

The step of cooling the cured film while it is moved may comprise a first temperature lowering step of reducing the temperature at a rate of 100° C./min to 1,000° C./min and a second temperature lowering step of reducing the temperature at a rate of 40° C./min to 400° C./min.

In such event, specifically, the second temperature lowering step is performed after the first temperature lowering step. The temperature lowering rate of the first temperature lowering step may be faster than the temperature lowering rate of the second temperature lowering step. For example, the maximum rate of the first temperature lowering step may be faster than the maximum rate of the second temperature lowering step. Alternatively, the minimum rate of the first temperature lowering step may be faster than the minimum rate of the second temperature lowering step.

If the step of cooling the cured film is carried in such a multistage manner, it is possible to have the physical properties of the cured film further stabilized and to maintain the optical properties and mechanical properties of the film achieved during the curing step more stably for a long period of time.

The moving speed of the gel-sheet and the moving speed of the cured film are the same.

The process for preparing a polyimide-based film comprises winding the cooled cured film using a winder (S500).

Referring to FIG. 3, the cooled cured film may be wound using a roll-shaped winder (50).

In such event, the ratio of the moving speed of the gel-sheet on the belt at the time of drying to the moving speed of the cured film at the time of winding is 1:0.95 to 1:1.40. For example, the ratio of the moving speeds may be 1:0.99 to 1:1.20, 1:0.99 to 1:1.10, or 1:1.10 to 1:1.05, but it is not limited thereto. If the ratio of the moving speeds is outside the above range, the mechanical properties of the cured film may be impaired, and the flexibility and elastic properties may be deteriorated.

Specifically, the moving speed of the gel-sheet on the belt at the time of drying may be 0.1 m/min to 15 m/min, for example, 0.5 m/min to 10 m/min.

In the process for preparing a polyimide-based film, the thickness variation (%) according to the following Equation 3 may be 3% to 30%, for example, 5% to 20%.

Thickness variation (%)=(M1−M2)/M2×100 [Equation 3]

In Equation 3, M1 is the thickness (sm) of the gel-sheet, and M2 is the thickness (μm) of the cooled cured film at the time of winding.

The physical properties of the polyimide-based film as described above are based on a thickness of 40 to 60 μm. For example, the physical properties of the polyimide-based film may be based on a thickness of 50 μm.

The polyimide-based film prepared by the preparation process as described above is excellent in optical properties and mechanical properties. The polyimide-based film may be applicable to various uses that require flexibility and transparency. For example, the polyimide-based film may be applied to solar cells, displays, semiconductor devices, sensors, and the like.

Display Device

An embodiment provides a cover window for a display, which comprises a polyimide-based film having an AFM modulus of a first side of 40 to 90 MPa and an AFM modulus of a second side opposite to the first side of 45 to 95 MPa. The polyimide-based film is the same as described above.

In addition, an embodiment provides a display device, which comprises a display panel; and a cover window disposed on the display panel.

The cover window comprises a polyimide-based film, wherein the polyimide-based film comprises a first side and a second side opposite to the first side, and the modulus asymmetry (MA) in the polyimide-based film according to the above Equation 1 is 0.03 to 0.2.

FIG. 2 is a cross-sectional view of a display device according to an embodiment. Specifically, FIG. 2 illustrates a display device, which comprises a display unit (400) and a cover window (300) disposed on the display unit (400), wherein the cover window comprises a polyimide-based film (100) having a first side (101) and a second side (102) and a functional layer (200), and an adhesive layer (500) is interposed between the display unit (400) and the cover window (300).

The display unit is for displaying an image, and it may have flexible characteristics.

The display unit may be a display panel for displaying an image. For example, it may be a liquid crystal display panel or an organic electroluminescent display panel. The organic electroluminescent display panel may comprise a front polarizing plate and an organic electroluminescent panel.

The front polarizing plate may be disposed on the front side of the organic electroluminescent panel. Specifically, the front polarizing plate may be attached to the side on which an image is displayed in the organic electroluminescent panel.

The organic electroluminescent panel displays an image by self-emission of a pixel unit. The organic electroluminescent panel may comprise an organic electroluminescent substrate and a driving substrate. The organic electroluminescent substrate may comprise a plurality of organic electroluminescent units, each of which corresponds to a pixel. Specifically, it may comprise a cathode, an electron transport layer, a light-emitting layer, a hole transport layer, and an anode. The driving substrate is operatively coupled to the organic electroluminescent substrate. That is, the driving substrate may be coupled to the organic electroluminescent substrate so as to apply a driving signal such as a driving current, so that the driving substrate can drive the organic electroluminescent substrate by applying a current to the respective organic electroluminescent units.

In addition, an adhesive layer may be interposed between the display unit and the cover window. The adhesive layer may be an optically transparent adhesive layer, but it is not particularly limited.

The cover window is disposed on the display unit. The cover window is located at the outermost position of the display device according to an embodiment to thereby protect the display panel.

The cover window may comprise a polyimide-based film and a functional layer. The functional layer may be at least one selected from the group consisting of a hard coating, a reflectance reducing layer, an antifouling layer, and an antiglare layer. The functional layer may be coated on at least one side of the polyimide-based film.

Hereinafter, the above description will be described in detail by referring to examples. But the following Examples are intended to illustrate the present invention, and the scope of the Examples is not limited thereto only.

### EXAMPLE

### Example 1: Preparation of a Polyimide-Based Film

A 1,000-liter glass reactor equipped with a temperature-controllable double jacket was charged with 250 kg of dimethylacetamide (DMAc) as an organic solvent at 20° C. under a nitrogen atmosphere. Then, 10 kg of 2,2′-bis(trifluoromethyl)-4,4′-diaminobiphenyl (TFMB) as an aromatic diamine was slowly added thereto and dissolved.

Subsequently, while 2.4 kg of 2,2′-bis(3,4-dicarboxyphenyl)hexafluoropropane dianhydride (6-FDA) as an aromatic dianhydride was slowly added thereto, the mixture was stirred for 1 hour, followed by addition of 150 g of barium sulfate as a filler and stirred thereof for 1 hour.

Then, 2.9 kg of terephthaloyl chloride (TPC) as a first dicarbonyl compound was added, which is 94% relative to the input moles, followed by stirring thereof for 1 hour. And 4.7 kg of 1,1′-biphenyl-4,4′-dicarbonyldichloride (BPDC) as a second dicarbonyl compound was added, followed by stirring thereof for 1 hour to prepare a first polyamide-imide solution.

The viscosity of the first polyamide-imide solution thus prepared was measured. If the measured viscosity did not reach the target viscosity, a TPC solution in a DMAc organic solvent at a concentration of 10% by weight was prepared, and 1 ml of the TPC solution was added to the first polyamide-imide solution, followed by stirring the mixture for 30 minutes. This procedure was repeated until the viscosity became about 200,000 cps, thereby preparing a second polyamide-imide solution.

The second polyamide-imide solution was transferred to a tank at −10° C. and stored. It was degassed for 1.5 hours so that the pressure in the tank reached 0.3 bar. The tank was purged with nitrogen gas at an internal pressure of 1.5 atm. Upon the purging, the second polyamide-imide solution was stored in the tank for 30 hours.

Subsequently, the second polyamide-imide solution was cast and then dried with hot air at 80° C. to 150° C. for 10 to 20 minutes, thereby producing a gel-sheet. Then, the gel-sheet was subjected to thermal treatment at 380° C. to 420° C. for 10 to 20 minutes while it was moved. Thereafter, a first temperature lowering step was carried out by reducing the temperature at a rate of about 800° C./min, followed by a second temperature lowering step by reducing the temperature at a rate of about 100° C./min, thereby obtaining a polyimide film, which was wound using a winder. Here, the speed of the winder was controlled such that the moving speed of the gel-sheet on the belt during drying was r m/min, and the ratio of the moving speed of the gel-sheet on the belt during drying to the moving speed of the film during winding was within the range of 1:1.01 to 1:1.10, thereby preparing a polyimide-based film (or polyamide-imide film) having a thickness of 50 μm.

### Examples 2 to 6: Preparation of a Polyimide-Based Film

Tests were performed in the same manner as in Example 1, except that the contents of the respective reactants, the temperature and time of drying, and the temperature and time of thermal treatment were changed as shown in Table 2.

TABLE 2

| | | | | | | | | Thermal |
|---|---|---|---|---|---|---|---|---|
| Part by weight | TFMB | 6-FDA | BPDA | TPC | BPDC | IPC | Drying | treatment |
| Ex. 1 | 100 | 24 | — | 29 | 47 | — | 80 to 150° C. | 380 to 420° C. |
| | | | | | | | 10 to 20 min. | 10 to 20 min. |
| Ex. 2 | 100 | — | — | 75 | — | 25 | 80 to 150° C. | 380 to 420° C. |
| | | | | | | | 10 to 20 min. | 10 to 20 min. |
| Ex. 3 | 100 | 3 | — | 75 | — | 22 | 80 to 150° C. | 380 to 420° C. |
| | | | | | | | 10 to 20 min. | 10 to 20 min. |
| Ex. 4 | 100 | 3 | — | 75 | — | 22 | 60 to 100° C. | 250 to 300° C. |
| | | | | | | | 10 to 20 min. | 10 to 20 min. |
| Ex. 5 | 100 | 3 | — | 75 | — | 22 | 80 to 150° C. | 380 to 420° C. |
| | | | | | | | 1 hour | 1 hour |
| Ex. 6 | 100 | 10 | 30 | 60 | — | — | 80 to 130° C. | 250 to 300° C. |
| | | | | | | | 30 mm. | 10 to 20 mm. |

### Evaluation Example

### Evaluation Example 1: AFM Modulus and AFM Hardness

The AFM modulus and AFM hardness were measured with AFM equipment (manufacturer: Park System, equipment name: XE-150) in a non-contact mode. The cantilever (manufacturer: Nanosensors, equipment name: NCHR) used when measuring the AFM hardness has the following product specifications.

TABLE 3

| | Non-contact mode |
|---|---|
| Force constant (N/m) | 0.2 |
| Resonance frequency (kHz) | 23 |
| Thickness (μm) | 1 |
| Mean width (μm) | 48 |
| Length (μm) | 225 |

### Evaluation Example 2: Tensile Strength

A sample was cut out by at least 5 cm in the direction perpendicular to the main shrinkage direction of the film and by 10 cm in the main shrinkage direction. It was fixed by the clips disposed at intervals of 5 cm in a universal testing machine UTM 5566A of Instron. A stress-strain curve was obtained until the sample was fractured while it was stretched at a rate of 5 mm/min at room temperature. The slope of the load with respect to the initial strain on the stress-strain curve was taken as the tensile strength (GPa).

### Evaluation Example 3: Surface Hardness

A pencil hardness tester was used to draw 5 times under the conditions of 0.5 kg and 10 mm according to ASTM D3363, and the presence or absence of a wound was then measured.

### Evaluation Example 4: Transmittance

The transmittance at 550 nm was measured using a haze meter NDH-5000W manufactured by Nippon Denshoku Kogyo.

### Evaluation Example 5: Haze

The haze was measured using a haze meter NDH-5000W manufactured by Nippon Denshoku Kogyo.

### Evaluation Example 6: Yellow Index

The yellow Index (Y.I.) was measured with spectrophotometer (UtraScan PRO, Hunter Associates Laboratory) using a CIE colorimetric system.

### Evaluation Example 7: Film Thickness

The thickness was measured at 5 points in the width direction using a digital micrometer 547-401 manufactured by Mitutoyo Corporation. Their average value was adopted as the thickness.

The results of Evaluation Examples 1 to 7 are shown in Tables 4 and 5 below.

TABLE 4

| | AFM modulus | | Modulus | AFM hardness | | Hardness |
|---|---|---|---|---|---|---|
| | (MPa) | | asymmetry | (MPa) | | asymmetry |
| | AM1 | AM2 | (MA) | AH1 | AH2 | (HA) |
| Ex. 1 | 62.38 | 72.90 | 0.144 | 17.23 | 18.63 | 0.075 |
| Ex. 2 | 70.36 | 76.01 | 0.074 | 33.24 | 35.75 | 0.070 |
| Ex. 3 | 71.29 | 77.61 | 0.081 | 31.26 | 33.57 | 0.069 |
| Ex. 4 | 62.75 | 67.26 | 0.067 | 18.34 | 19.62 | 0.065 |
| Ex. 5 | 61.85 | 64.32 | 0.038 | 32.92 | 34.16 | 0.036 |
| Ex. 6 | 59.46 | 63.24 | 0.060 | 17.95 | 18.69 | 0.040 |

TABLE 5

| | Tensile | | | | Yellow | |
|---|---|---|---|---|---|---|
| | strength | Surface | Transmittance | Haze | index | Thickness |
| | (GPa) | hardness | (%) | (%) | (Y.I.) | (μm) |
| Ex. 1 | 6.5 | 2H | 89.1 | 0.4 | 2.2 | 50 |
| Ex. 2 | 7.2 | 4H | 89.1 | 0.4 | 2.7 | 50 |
| Ex. 3 | 7.4 | 4H | 88.8 | 0.4 | 2.6 | 50 |
| Ex. 4 | 6.8 | 2H | 89.0 | 0.6 | 2.5 | 50 |
| Ex. 5 | 6.7 | 4H | 88.9 | 0.5 | 3.6 | 50 |
| Ex. 6 | 7.0 | 2H | 88.5 | 0.6 | 3.4 | 50 |

As shown in Tables 4 and 5 above, the films prepared in the Examples had excellent mechanical properties and optical properties such as tensile strength, surface hardness, haze, modulus, yellow index, and transmittance.

### REFERENCE NUMERALS OF THE DRAWINGS

10: polymerization apparatus
20: tank
30: casting body (casting belt)
40: thermosetting device
50: winder
100: polyimide-based film
101: first side
102: second side
200: functional layer
300: cover window
400: display unit
500: adhesive layer

1. A polyimide-based film, which comprises:
a first side and a second side opposite to the first side,
wherein the modulus asymmetry (MA) according to the following Equation 1 is 0.03 to 0.2:
$$MA = \frac{AM 2 - AM 1}{AM 2} \qquad [ Equation 1 ]$$
in Equation 1,
AM1 is an AFM modulus measured from the first side by atomic force microscopy,
AM2 is an AFM modulus measured from the second side by atomic force microscope, and
AM2 is greater than AM1.

2. The polyimide-based film of claim 1, wherein AM1 is 40 to 90 MPa, and AM2 is to 95 MPa.

3. The polyimide-based film of claim 2, wherein the difference between AM1 and AM2 is 15 MPa or less.

4. The polyimide-based film of claim 1, wherein the hardness asymmetry (HA) according to the following Equation 2 is 0.03 to 0.1:
$$HA = \frac{AH 2 - AH 1}{AH 2} \qquad [ Equation 2 ]$$
in Equation 2,
AH1 is an AFM hardness measured from the first side by atomic force microscope,
AH2 is an AFM hardness measured from the second side by atomic force microscope, and
AH2 is greater than AH1.

5. The polyamide-imide film of claim 4, wherein AH is 15 to 40 MPa, and AH2 is 18 to 50 MPa.

6. The polyamide-imide film of claim 5, the difference between AH1 and AH2 is 10 MPa or less.

7. The polyimide-based film of claim 1, which comprises a polyamide-imide derived from an aromatic dianhydride compound, an aromatic diamine compound, and a dicarbonyl compound.

8. The polyimide-based film of claim 7, wherein the aromatic dianhydride compound comprises 2,2′-bis-(3,4-dicarboxyphenyl)hexafluoropropane dianhydride, 3,3′,4,4′-biphenyltetracarboxylic dianhydride, or a combination thereof.

9. The polyimide-based film of claim 7, wherein the aromatic diamine compound comprises 2,2′-bis(trifluoromethyl)-4,4′-diaminobiphenyl.

10. The polyimide-based film of claim 7, wherein the dicarbonyl compound comprises terephthaloyl chloride, 1,1′-biphenyl-4,4′-dicarbonyl dichloride, isophthaloyl chloride, or a combination thereof.

11. The polyimide-based film of claim 7, wherein, the dicarbonyl compound comprises a first dicarbonyl compound and a second dicarbonyl compound,
the first dicarbonyl compound is terephthaloyl chloride, and
the second dicarbonyl compound is 1,1′-biphenyl-4,4′-dicarbonyl dichloride, isophthaloyl chloride, or a combination thereof.

12. The polyimide-based film of claim 7, wherein the polyamide-imide comprises 0 to 50 parts by weight of the aromatic dianhydride compound and 50 to 100 parts by weight of the dicarbonyl compound based on 100 parts by weight of the aromatic diamine compound.

13. The polyimide-based film of claim 1, which has a tensile strength of 4.0 GPa or more.

14. The polyimide-based film of claim 1, which has a surface hardness of 2H or higher, a transmittance of 85% or more, a haze of 3% or less, and a yellow index (Y.I.) of or less.

15. The polyimide-based film of claim 1, which has a thickness of 10 μm to 200 μm.

16. A process for preparing a polyimide-based film, which comprises:
simultaneously or sequentially mixing and reacting an aromatic dianhydride compound, an aromatic diamine compound, and a dicarbonyl compound in an organic solvent to prepare a polyamide-imide solution;
casting the polyamide-imide solution and then drying it to prepare a gel-sheet;
thermally treating the gel-sheet, while it is moved on a belt, to prepare a cured film; and
winding the cured film,
wherein the drying is carried out at a temperature of 60° C. to 200° C. for 10 minutes to 90 minutes,
the thermal treatment is carried out at 200° C. to 450° C. for 10 minutes to 120 minutes,
the AFM modulus of a first side of the cured film is 40 to 90 MPa, the AFM modulus of a second side opposite to the first side is 45 to 95 MPa, and the difference between the AFM modulus of the first side and the AFM modulus of the second side is 15 MPa or less.

17. The process for preparing a polyimide-based film of claim 16, wherein the drying is carried out at a temperature of 80° C. to 150° C. for 10 minutes to 20 minutes, and the thermal treatment is carried out at 380° C. to 420° C. for 10 minutes to 20 minutes.

18. A display device, which comprises:
a display panel; and
a cover window disposed on the display panel,
wherein the cover window comprises a polyimide-based film,
the polyimide-based film comprises a first side and a second side opposite to the first side, and
the modulus asymmetry (MA) in the polyimide-based film according to the following Equation 1 is 0.03 to 0.2:
$$MA = \frac{AM 2 - AM 1}{AM 2} \qquad [ Equation 1 ]$$
in Equation 1,
AM1 is an AFM modulus measured from the first side by atomic force microscope,
AM2 is an AFM modulus measured from the second side by atomic force microscope, and
AM2 is greater than AM1.

19. The display device of claim 18, wherein AM1 is 40 to 90 MPa, AM2 is 45 to 95 MPa, and the difference between AM1 and AM2 is 15 MPa or less.

20. The display device of claim 18, wherein the hardness asymmetry (HA) in the polyimide-based film according to the following Equation 2 is 0.03 to 0.1:
$$HA = \frac{AH 2 - AH 1}{AH 2} \qquad [ Equation 2 ]$$
in Equation 2,
AH1 is an AFM hardness measured from the first side by atomic force microscope,
AH2 is an AFM hardness measured from the second side by atomic force microscope, and
AH2 is greater than AH1.
